(19) United States
(12) Patent Application Publication
(10) Pub. No.: US 2025/0132987 A1
(43) Pub. Date: Apr. 24, 2025

(54) Synergy Aware Path Creation in a Network Computing Environment

(71) Applicant: International Business Machines Corporation, Armonk, NY (US)

(72) Inventors: Sudheesh S. KAIRALI, Kozhikode (IN); Satyam JAKKULA, Bengaluru (IN); Sarbajit K. RAKSHIT, Kolkata (IN); Sudhanshu Sekher SAR, Bangalore (IN)

(21) Appl. No.: 18/491,376

(22) Filed: Oct. 20, 2023

(51) Int. Cl. H04L 12/18

(52) U.S. Cl. CPC H04L 41/40; G06N 3/04

(57) ABSTRACT

A computer implemented method for computing device collaboration. A number of processor units identify computing device groupings for collaboration in processing data based on synergy levels between the computing device groupings. The computing device groupings process a set of common data types. The number of processor units instruct the computing device groupings to share the data for the set of common data types. The number of processor units deploy a number of relay devices to facilitate communications between the computing device groupings in response to the computing device groupings not being in communication with each other.

### BACKGROUND

The disclosure relates generally to improved computing system and more specifically to selectively enabling communications between edge computing surroundings.

An edge computing network is a distributed computing architecture that moves the processing of data and the storage of data where the data is needed. This type of architecture can improve response times and save bandwidth. In this example, computing nodes in the network are also referred to as edge devices. These nodes are typically located closer to the data source, or “edge” of the network as compared to a centralized data center or cloud architecture. This type of processing can be useful with Internet of Things (IoT) devices. In this case, edge devices can be IoT such as sensors and embedded devices. These types of devices can generate very large amounts of data.

Further in an edge computing network, the data processing can be performed by the edge device that includes performing an action. For example, an edge device such as a thermostat can adjust the room temperature based on sensor data. In another example, the data processing can be performed by a server that is geographically located nearby to devices requesting data processing.

Thus, edge computing moves more processing resources closer to end-users. As result, the number of endpoints increases with those endpoints being located closer to the consumers. These consumers are users or devices that use the process data to perform different tasks or functions. For example, the consumer can be a smart phone application providing recommendations or a self-driving vehicle determining a route.

### SUMMARY

According to one illustrative embodiment, a computer implemented method for computing device collaboration. A number of processor units identify computing device groupings for collaboration in processing data based on synergy levels between the computing device groupings. The computing device groupings process a set of common data types. The number of processor units instruct the computing device groupings to share the data for the set of common data types. The number of processor units deploy a number of relay devices to facilitate communications between the computing device groupings in response to the computing device groupings not being in communication with each other. According to other illustrative embodiments, a computer system and a computer program product for computer device collaboration is provided.

### BRIEF DESCRIPTION OF THE DRAWINGS

FIG. 1 is a block diagram of a computing environment in accordance with an illustrative embodiment;

FIG. 2 is a block diagram of a data processing environment in accordance with an illustrative embodiment;

FIG. 3 is a computing environment using computing device groupings for collaboration in processing data in accordance with an illustrative embodiment;

FIG. 4 is a flowchart of a process for computing device collaboration in accordance with an illustrative embodiment;

FIG. 5 is a flowchart of a process for identifying computing device groupings in accordance with an illustrative embodiment;

FIG. 6 is a flowchart of a process for identifying computing device groupings in accordance with an illustrative embodiment;

FIG. 7 is a flowchart of a process for determining synergy levels in points with an illustrative embodiment;

FIG. 8 is a flowchart of a process for deploying a set of relay devices in accordance with an illustrative embodiment;

FIG. 9 is a flowchart of a process for determining a set of optimal deployment locations in accordance with an illustrative embodiment;

FIG. 10 is a flowchart of a process for determining a set of optimal deployment locations in accordance with an illustrative embodiment;

FIG. 11 is a flowchart of a process for deploying a set of relay devices in accordance with an illustrative embodiment;

FIG. 12 is a flowchart of a process for computing device collaboration in accordance with an illustrative embodiment; and

FIG. 13 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

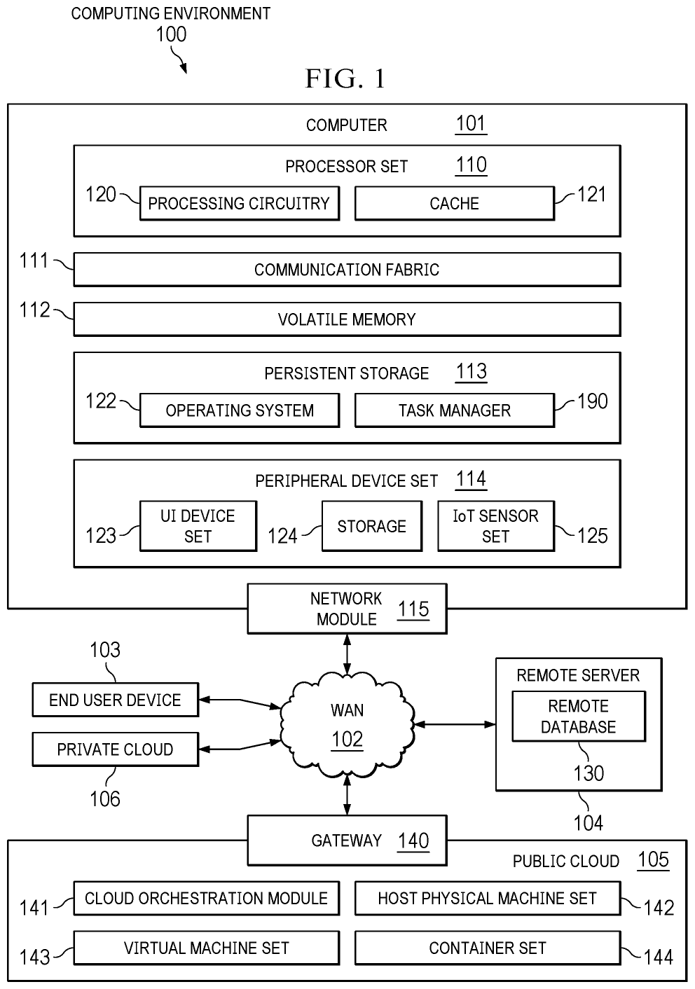

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as task manager 190. In addition to task manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and task manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in task manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in task manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of different considerations as described herein. For example, with edge computing networks, a sufficient number of far edge devices are needed to provide processing resources needed for different tasks.

In this example, the number of far edge devices need to be sufficient to collaborate with each other to share the computational load and provide more efficient processing of tasks. This type of collaboration can be useful when large amounts of data are present that need to be processed in real time. By distributing the processing tasks to different far edge devices, latency can be reduced, bandwidth usage can be reduced, and processing performance can be increased.

For example, in agriculture, crop management can be performed using far edge devices such as tractors, harvesters, irrigation devices, and drones that have sensors. Edge devices collect data about temperature, weather conditions, soil conditions, crops, and other conditions. This data can be processed in real time to enable making decisions regarding watering, fertilizing, harvesting, and other decisions for managing crops.

Duplication of data collection can occur. For example, both tractors and irrigation devices can collect temperature data in a field. The tractors and irrigation devices can both process the temperature data in a collaborative manner. In this example, both the tractors and irrigation devices process the temperature data. However, all of these devices do not need to collect temperature data for processing. This collection of temperature data by all the edge devices is redundant and can reduce the amount of processing resources available and increase processing time.

Groups of computing devices can be defined for processing data. Each group can be in a physical area in which data processing of sensor data or other data collected from that physical location is required at the same point in time. Each group of far edge devices are able to communicate with each other to process the data in a collaborative manner. A group of computing devices defined for collecting data processing in a physical location can also be referred to as a computing device grouping or an edge computing surrounding.

Multiple groups can be present in the geographic location in which the same data is being processed for a task, but those different groups are unable to communicate with each other. The distance or other environmental conditions may result in low signal strength that prevents collaboration between these different groups in the geographic location. This processed data can be sent back to a central location for further processing.

However, having more processing of processing of the data remain with these devices is often desirable to use of processing resources devices in the computing device groupings. With this situation, synergy can be present between these different computing device groupings because they process data for the same task. As a result, enabling communication between these computing device groupings can take advantage of the synergy.

With different computing device groupings processing the same data, not all of the computing devices in these different groupings need to collect data. Instead, some of the computing devices in the computing device groupings can collect data and share the data with other computing devices in other computing device groupings.

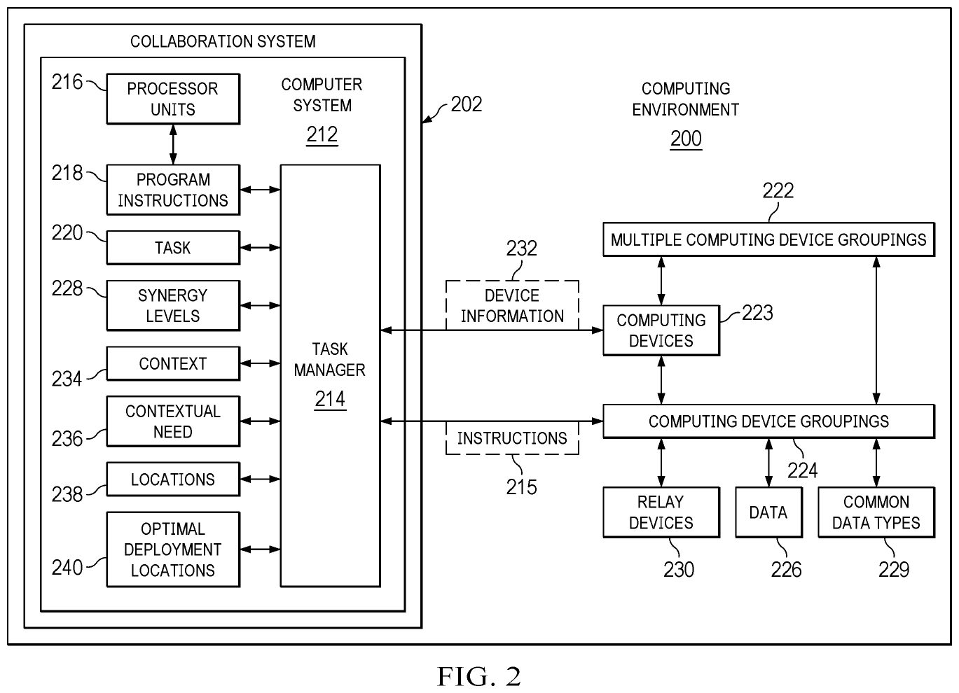

With reference now to FIG. 2, a block diagram of a data processing environment is depicted in accordance with an illustrative embodiment. In this illustrative example, computing environment 200 includes components that can be implemented in hardware such as the hardware shown in computing environment 100 in FIG. 1.

In this illustrative example, collaboration system 202 can manage processing tasks in which collaboration occurs between computing device groupings. In this example, collaboration system 202 comprises computer system 212 and task manager 214. Task manager 214 may be implemented using task manager 190 in FIG. 1.

Task manager 214 can be implemented in software, hardware, firmware or a combination thereof. When software is used, the operations performed by task manager 214 can be implemented in program instructions configured to run on hardware, such as a processor unit. When firmware is used, the operations performed by task manager 214 can be implemented in program instructions and data and stored in persistent memory to run on a processor unit. When hardware is employed, the hardware can include circuits that operate to perform the operations in task manager 214.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, task manager 214 manages the processing of task 220. Processing of task 220 can be performed in a distributed manner using multiple computing device groupings 222. In this example, multiple computing device groupings are groupings of computing devices 223. These computing devices can be mobile or stationary computing devices. Computing devices 223 can be selected from at least one of a laptop computer, smart glasses, virtual reality goggles, a video doorbell, a smart speaker, a smart thermostat, a temperature sensor, a traffic sensor, a road surface sensor, a car, a moisture sensor, a weather station, a smart sprinkler, a flowmeter, a smart camera, a robot, a wearable device, a far edge device, a near edge device, a computer, a network attached storage, a cloud storage device, a gateway, a hub, a mobile computing device, a stationary computing device, or other suitable types of devices that can process data and communicate with a network or other computing devices.

In this example, computing device groupings 224 can be identified from a portion of multiple computing device groupings 222. A computing device grouping in computing device groupings 224 in multiple computing device groupings 222 can be an edge computing surrounding.

In this example, a computing device grouping is a group of devices that collect or process, or both collect and process, the same type of data. When a computing device grouping is an edge computing surrounding, the computing devices in the edge computing surrounding are edge devices. The type of data processed by two computing device groupings can have an overlap.

In this example, task manager 214 identifies computing device groupings 224 for collaboration in processing data 226 based on synergy levels 228 between computing device groupings 224. Further, in this example, computing device groupings 224 process a set of common data types 229.

As used herein, a “set of” when used with reference to items means one or more items. For example, a set of common data types 229 is one or more of the set of common data types 229.

Task manager 214 instructs computing device groupings 224 to share data 226 for the set of common data types 229. This example, task manager 214 can send instructions 215 in the form of at least one of commands, data, configuration information, program code, or other suitable information that can provide instructions on sharing data 226. Instructions 215 can also include information about performing task 220. Additionally, instructions 215 may give individual groups of computing devices particular subtasks from within task 220.

Further, task manager 214 deploys a number of relay devices 230 to facilitate communications between computing device groupings 224 in response to computing device groupings 224 not being in communication with each other. In this illustrative example, relay devices 230 can be at least one of a router, a wireless access point, a network repeater, a gateway, a range extender, a wireless hub, a wireless bridge, a wireless drone, or other devices that can operate or be configured to facilitate communications between computing devices 223 in computing device groupings 224. In these illustrative examples, the number of relay devices 230 can be deployed to form a communications path from one computing device grouping to another computing device grouping in computing device groupings 224.

In this example, computing device groupings 224 can be identified by task manager 214 in a number of different ways. For example, task manager 214 can identify multiple computing device groupings 222 available for collaboration in processing the data 226 for task 220. In this example, available means that a particular computing device grouping has resources available to perform processing for tasks.

Task manager 214 determines synergy levels 228 between multiple computing device groupings 222 for task 220 using context 234 for multiple computing device groupings 222. For example, task manager 214 can receive device information 232 from computing devices 223 in multiple computing device groupings 222.

In this example, task manager 214 determines context 234 for multiple computing device groupings 222 from device information 232 received from computing devices 223 in multiple computing device groupings 222. Also in this illustrative example, device information 232 includes information about the multiple computing device groupings 222. For example, device information 232 can include at least one of reachability, availability of resources for computations, upload capability, download capability, locality, ability, or other information about a computing device.

Task manager 214 identifies computing device groupings 224 for collaboration in processing data 226 for task 220 from multiple computing device groupings 222 using synergy levels 228. In one example, task manager 214 determines synergy levels 228 between multiple computing device groupings 222 using context 234 and contextual need 236.

In this example, contextual need 236 is information about processing resources or capabilities that are needed for task 220. For example, particular types of processors may be needed for processing certain types of data 226. Further, a selected amount of storage space also may be needed to store intermediate results in processing data 226. Also, depending on task 220, a particular upload and download level may be needed to communicate with task manager 214 in performing task 220. This and other information needed for task 220 forms contextual need 236 in this example.

Other information can also be considered by task manager 214 in identifying computing device groupings 224 from multiple computing device groupings 222. In one illustrative example, locations 238 of multiple computing device groupings 222 can be used to determine whether communications are possible between different computing device groupings in multiple computing device groupings 222. This determination can be used in identifying or selecting computing device groupings 224.

In some cases, the use of relay devices 230 can provide the needed communication resources for collaboration. In other illustrative examples, the distance may be too great to practically use relay devices 230. Further, the use of locations 238 can also be considered in determining whether particular mobile computing device groupings can be used for task 220.

In deploying relay devices 230, task manager 214 determines a set of optimal deployment locations 240 to use a minimum number of relay devices 230 for the set of relay devices 230. In determining the set of optimal deployment locations 240, the distance between computing device groupings 224 can be used. Further, task manager 214 can also take into account the movement of computing devices 223 in computing device groupings 224 in determining the set of optimal deployment locations 240.

Further, as part of deploying the set of relay devices 230, task manager 214 can dynamically reposition the set of relay devices 230 as needed. For example, task manager 214 can reposition the set of relay devices 230 in response to an undesired level of communications occurring between the computing device groupings 224. This repositioning can be changing a position of one or more of the set of relay devices 230. In another illustrative example, task manager 214 can deploy additional relay devices in response to the undesired level of communications occurring between the computing device groupings 224. The undesired level can be an undesired amount of latency, a communications speed that is slower than needed for a task, or error rates that are too high for transmitting or receiving data.

This undesired level of communications can occur for a number of different reasons. For example, movement of one or more of the computing device groupings 224 can cause changes in signal strength. As another example, environmental conditions may increase interference in communications.

In one illustrative example, one or more solutions are present that overcome a problem with providing a desired level of collaboration to provide processing resources for performing different tasks. As a result, one or more solutions enable identifying groups processing devices that can be used to collaborate with each other to increase processing resources available for performing a task.

Computer system 212 can be configured to perform at least one of the steps, operations, or actions described in the different illustrative examples using software, hardware, firmware or a combination thereof. As a result, computer system 212 operates as a special purpose computer system in which task manager 214 in computer system 212 enables collaboration between computing devices to process data. In particular, task manager 214 transforms computer system 212 into a special purpose computer system as compared to currently available general computer systems that do not have task manager 214.

In the illustrative example, task manager 214 in computer system 212 integrates processes into a practical application for computing device collaboration and increases the performance of computer system 212 in performing tasks. In other words, task manager 214 in computer system 212 is directed to a practical application of processes integrated into task manager 214 in computer system 212 that identify computing device groupings that can be used for collaboration, instructing those groupings to share data for the common data types being processed, and the deploying relay devices as needed to facilitate communications between the computing device groupings.

The illustration of computing environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, task manager 214 can manage data sharing collaboration for one or more tasks in addition to or in place of task 220. In this illustrative example, computing devices 223 and relay devices 230 can be considered part of computer system 212. In another illustrative example, task manager 214 can dynamically readjust computing device groupings 224 to add or remove computing device groupings based on the performance of task 220.

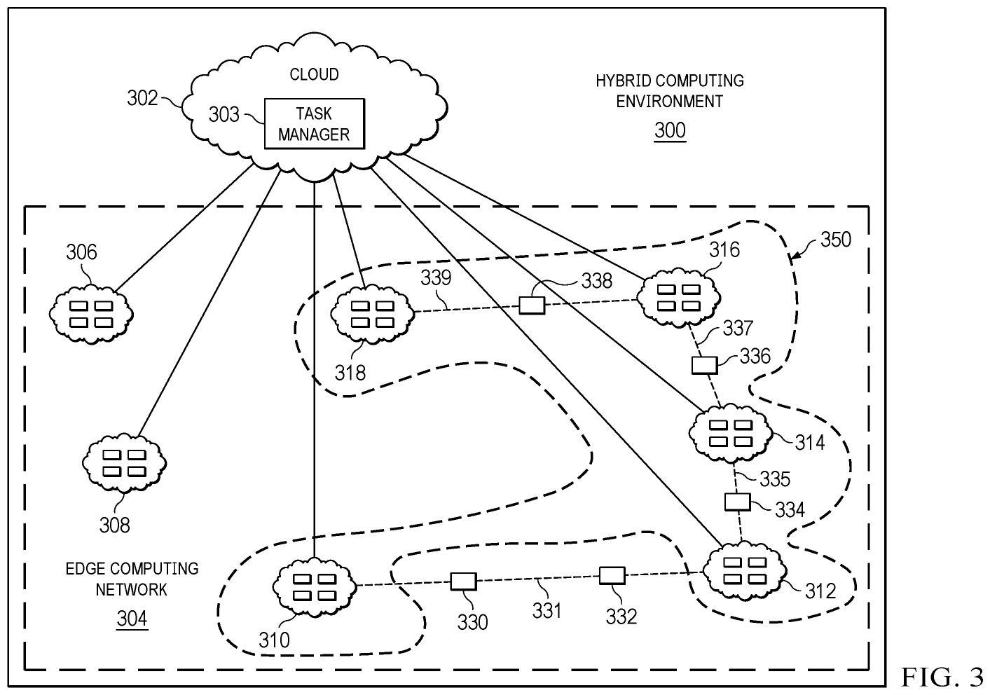

With reference next to FIG. 3, a computing environment using computing device groupings for collaboration in processing data is depicted in accordance with an illustrative embodiment. In this illustrative example, hybrid computing environment 300 is an example of an implementation for computing environment 100 in FIG. 1 and computing environment 200 in FIG. 2. Further, hybrid computing environment 300 takes the form of a hybrid cloud and edge computing system. Hybrid computing environment 300 includes cloud 302 and edge computing network 304. This hybrid system leverages the power of both centralized and decentralized computing.

In this illustrative example, cloud 302 provides centralized computing power with large amounts of storage. Cloud 302 can operate as a central location for managing and processing large amounts of data, running applications, and providing accessibility to services.

Further in this example, edge computing network 304 includes far edge devices such as Internet of things (IoT) in other computing devices located at the edge of the network that can collect and process data locally. The use of edge computing network 304 can be used to reduce latency and process data closer to the source of data. The combination of cloud 302 and edge computing network 304 provides flexible and scalable processing resources for performing many different types of tasks.

In this illustrative example, edge computing surroundings are groupings of computing devices in edge computing network 304. In this example, the computing devices in an edge computing surrounding are predefined to include computing devices that can be used to process data and perform tasks as a group. In this example, edge computing surroundings include edge computing surrounding 306, edge computing surrounding 308, edge computing surrounding 310, edge computing surrounding 312, edge computing surrounding 314, edge computing surrounding 316, and edge computing surrounding 318. Different edge computing surroundings communicate with cloud 302. However, these different edge computing surroundings may be unable to communicate with each other. In this illustrative example, task manager 303 in cloud 302 can identify edge computing surroundings that can participate in edge computing.

In identifying edge computing surroundings, task manager 303 receives device information from computing devices in the different edge computing surroundings in edge computing network 304. This information can be used to determine which edge computing surroundings have computing capabilities that can be used for performing tasks. In this example, task manager 303 tracks available edge computing capacity and the edge computational load. The edge computing capacity indicates the amount of processing resources available. The edge computational load identifies what processing resources are being used.

Further in identifying edge computing surroundings, task manager 303 can also use the device information to determine the context for each of the edge computing surroundings. Task manager 303 identifies synergies between these different edge computing surroundings using the context and facilitates communications between the different edge computing surroundings.

Task manager 303 determines synergy between different edge computing surroundings to perform one or more tasks. In this example, the synergy can be between edge computing surroundings already performing processing for the same task. In another illustrative example, synergy can be determined for edge computing surroundings that may be used to form a new task.

In one illustrative example, historical data can be used to determine synergies between different edge computing surroundings. In this illustrative example, the historical data can be used to train a machine learning model that is used by task manager 303 to predict synergy between different edge computing surroundings.

In this example, task manager 303 identifies the synergy levels between the different edge computing surroundings. Further, task manager 303 also identifies the physical distance and any movement for each of the edge computing surroundings. The synergy level can be based on different factors. For example, synergy level can be determined by task manager 303 using factors selected from at least the type of data collected, the type of data processed, overlap between data collection, overlap in data processing, or other suitable factors.

Other factors that can be considered also include sizes of the areas or distances from which data is to be collected. For example, a determination can be made as to whether local data is to be analyzed or if a wide range of data is to be analyzed.

For example, air quality in a warehouse can be evaluated. This air quality can be a wide area and intermediate relay devices can be established to share data between computing device groupings in the warehouse to analyze the air quality for the warehouse.

In another example, synergy can be present in processing the same data and not just the same type of data. For example, with two computing device groupings of edge devices, a first computing device grouping has more computing resources than a second computing device grouping. In this example, the second computing device grouping captures a large amount of data that cannot be processed by the second device grouping without an undesired level of latency. Additional computing time may be available to process all this data when the first computing device grouping collaborates with second computing device grouping to process the data. Relay devices can be deployed to provide communications between these two computing device groupings. This communications enabling sharing the data captured by the second computing device grouping with the first computing device grouping to provide available processing resources such that a desired latency is not present in processing the data captured by the second computing device grouping.

In this example, edge computing surrounding 310, edge computing surrounding 312, edge computing surrounding 314, edge computing surrounding 316, and edge computing surrounding 318 have been selected as edge computing surroundings 350 for collaboration in processing data for a task. In this example, however, these edge computing surroundings are not in communication with each other. To take advantage of the synergy in having these edge computing surroundings collaborate with each other and processing data, task manager 303 can create communication paths between the edge computing surroundings.

Task manager 303 can cause the deployment relay devices to facilitate communications between edge computing surroundings that have been selected for collaboration with each other. In this example, these relay devices comprise relay device 330, relay device 332, relay device 334, relay device 336, and relay device 338. In this example, relay device 330 and relay device 332 are used to establish communication path 331 between edge computing surrounding 310 and edge computing surrounding 312. Relay device 334 is used to establish communications path 335 between edge computing surrounding 312 and edge computing surrounding 314. Further in this example, relay device 336 establishes communications path 337 between edge computing surrounding 314 and edge computing surrounding 316. Relay device 338 is used to establish indications path 339 between edge computing surrounding 316 and edge computing surrounding 318. With these communication paths, data can be shared between edge computing surroundings 350.

The relay device can be deployed by using the relay device to establish the communications path. In this illustrative example, the deployment of a relay device can be performed in a number of different ways. For example, a relay device can already be in position but not used to establish a communications path. In this case, the relay device can be activated or configured to establish the communications path. In another example, a relay device can be moved to a location where that relay device can establish a communications path between two or more edge computing surroundings.

With this sharing of data, efficiencies can be achieved through having selected edge computing surroundings collect data. Other edge computing surroundings do not collect data that is of the same type collected by the selected edge computing surroundings. As a result, only some of the edge computing surroundings collect data. Other edge computing surroundings can focus on processing the collected data.

In this example, edge computing surrounding 315 can collect a common data type such as temperature and soil moisture. With common data types, not all of the edge computing surroundings need to collect temperature data and soil moisture data. For example, based on the location of edge computing surroundings 350, task manager 303 can instruct edge computing surrounding 310 to collect the temperature data and edge computing surrounding 314 to collect moisture soil data.

The temperature data and soil moisture data can share with the other edge computing surroundings. This type of data collection can be especially useful if some of the edge collecting surroundings do not have temperature or moisture sensors. As result, all of the edge collection surroundings can process data collaboratively. In this example, some edge computing surroundings in edge computing surroundings 350 may also collect other data that is not a common data type and process that data separately.

The illustration of hybrid computing environment 300 is presented as an example and not meant to limit the manner in which other illustrative examples can be implemented. Another illustrative example can be implemented using an edge computing network rather than a hybrid network. In yet another illustrative example, a computer system with mobile computing devices can be used.

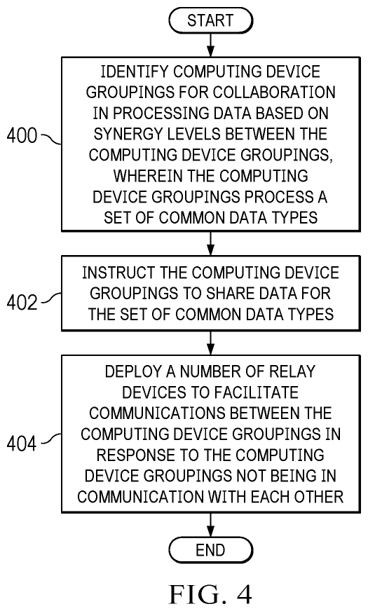

Turning next to FIG. 4, a flowchart of a process for computing device collaboration is depicted in accordance with an illustrative embodiment. The process in FIG. 4 can be implemented in hardware, software, or both. When implemented in software, the process can take the form of program instructions that are run by one or more processor units located in one or more hardware devices in one or more computer systems. For example, the process can be implemented in one or more of task manager 190 in FIG. 1, task manager 214 in computer system 212 in FIG. 2, and in task manager 303 in FIG. 3.

The process begins by identifying computing device groupings for collaboration in processing data based on synergy levels between the computing device groupings, wherein the computing device groupings process a set of common data types (step 400). The process instructs the computing device groupings to share data for the set of common data types (step 402).

The process deploys a number of relay devices to facilitate communications between the computing device groupings in response to the computing device groupings not being in communication with each other (step 404). The process terminates thereafter.

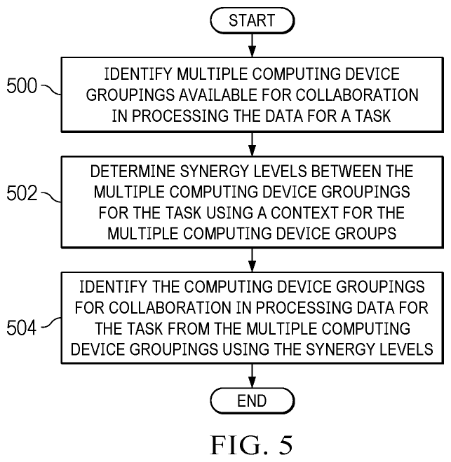

With reference now to FIG. 5, a flowchart of a process for identifying computing device groupings is depicted in accordance with an illustrative embodiment. The process in this figure is an example of an implementation for step 400 in FIG. 4.

The process identifies multiple computing device groupings available for collaboration in processing the data for a task (step 500). The process determines synergy levels between the multiple computing device groupings for the task using a context for the multiple computing device groups (step 502).

The process identifies the computing device groupings for collaboration in processing data for the task from the multiple computing device groupings using the synergy levels (step 504). The process terminates thereafter.

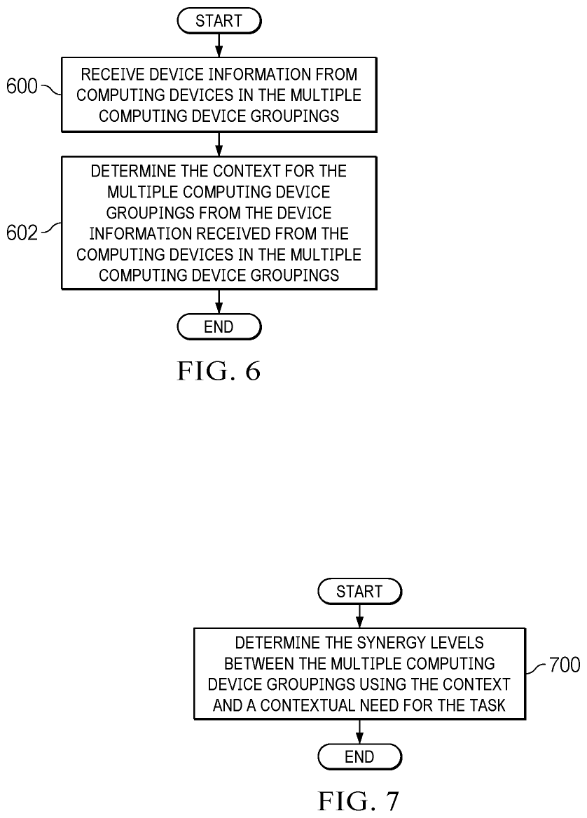

Turning to FIG. 6, a flowchart of a process for identifying computing device groupings is depicted in accordance with an illustrative embodiment. The process in this flowchart is an example of an additional step that can be performed with the steps in FIG. 5 to identify computing device groupings.

The process receives device information from computing devices in the multiple computing device groupings (step 600). The process determines the context for the multiple computing device groupings from the device information received from the computing devices in the multiple computing device groupings (step 602). The process terminates thereafter.

In FIG. 7, a flowchart of a process for determining synergy levels is depicted in points with an illustrative embodiment. The process in this figure is an example of a step that can be performed to determine synergy levels used in the steps in FIG. 5.

The process determines the synergy levels between the multiple computing device groupings using the context and a contextual need for the task (step 700). The process terminates thereafter.

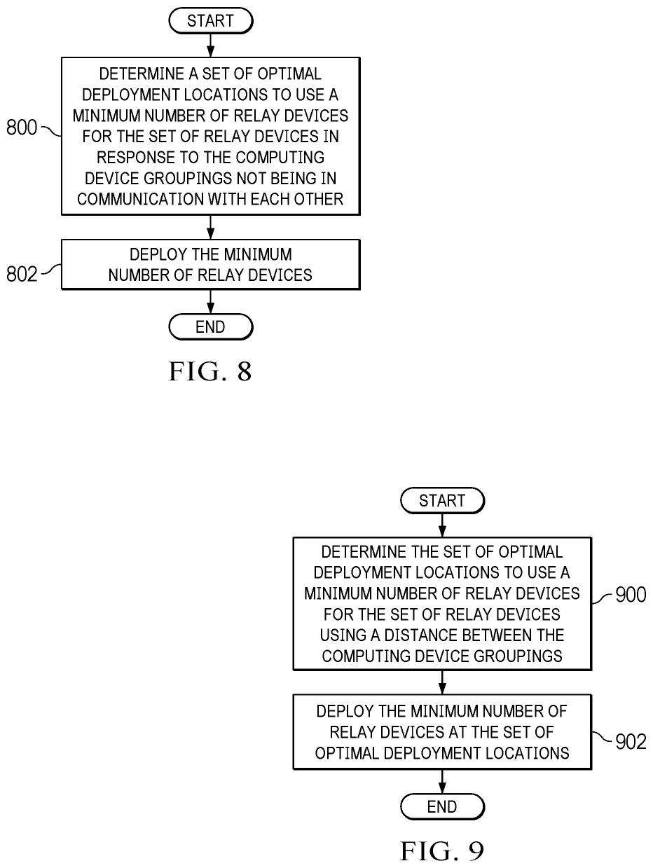

Turning to FIG. 8, a flowchart of a process for deploying a set of relay devices is depicted in accordance with an illustrative embodiment. The process in this figure is an example of an implementation for step 404 in FIG. 4.

The process determines a set of optimal deployment locations to use a minimum number of relay devices for the set of relay devices in response to the computing device groupings not being in communication with each other (step 800). The process deploys the minimum number of relay devices (step 802). The process terminates thereafter.

With reference now to FIG. 9, a flowchart of a process for determining a set of optimal deployment locations is depicted in accordance with an illustrative embodiment. The process in this figure is an example of an implementation for step 800 in FIG. 8.

The process determines the set of optimal deployment locations to use a minimum number of relay devices for the set of relay devices using a distance between the computing device groupings (step 900). The process deploys the minimum number of relay devices at the set of optimal deployment locations (step 902). The process terminates thereafter.

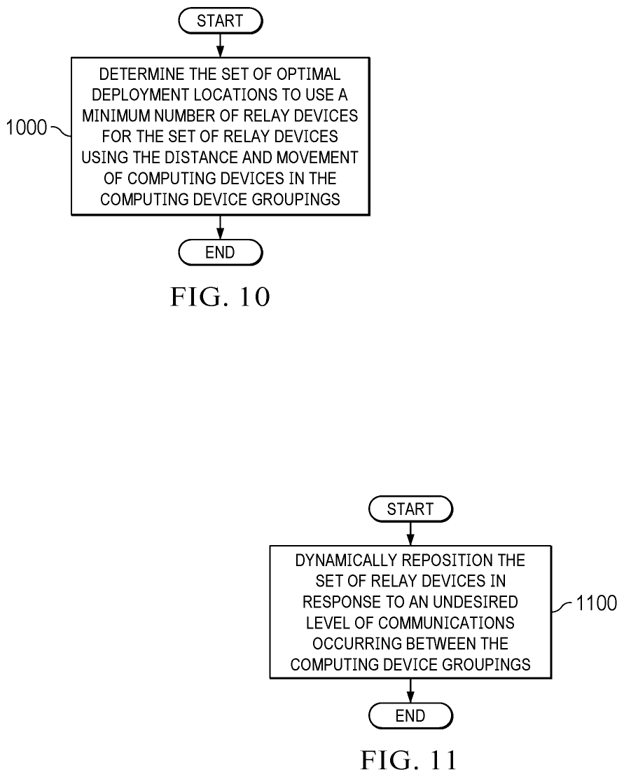

Next in FIG. 10, a flowchart of a process for determining a set of optimal deployment locations is depicted in accordance with an illustrative embodiment. The process in FIG. 10 is an example of an implementation for step 900 in FIG. 9.

The process determines the set of optimal deployment locations to use a minimum number of relay devices for the set of relay devices using the distance and movement of computing devices in the computing device groupings (step 1000). The process terminates thereafter.

In FIG. 11, a flowchart of a process for deploying a set of relay devices is depicted in accordance with an illustrative embodiment. The process in this flowchart is an example of an additional step that can be performed in deploying relay devices in step 404 in FIG. 4.

The process dynamically repositions the set of relay devices in response to an undesired level of communications occurring between the computing device groupings (step 1100). The process terminates thereafter.

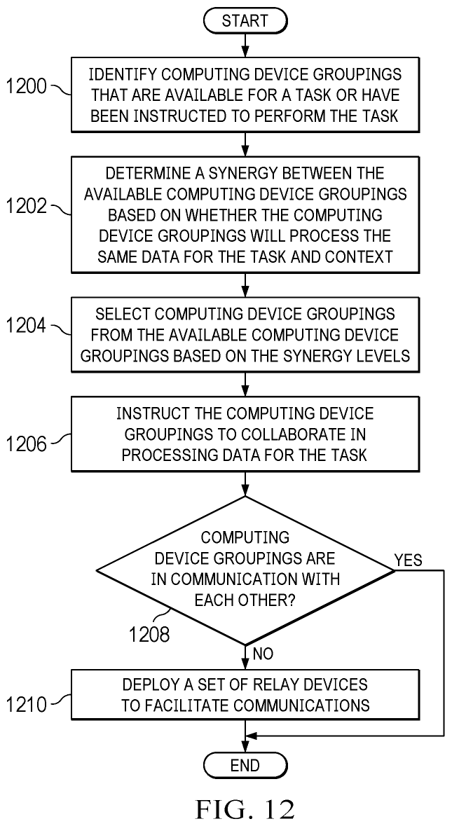

With reference now to FIG. 12, a flowchart of a process for computing device collaboration is depicted in accordance with an illustrative embodiment. The process in FIG. 12 can be implemented in hardware, software, or both. When implemented in software, the process can take the form of program instructions that are run by one of more processor units located in one or more hardware devices in one or more computer systems. For example, the process can be implemented in one or more of task manager 190 in FIG. 1, task manager 214 in computer system 212 in FIG. 2, and in task manager 303 in FIG. 3.

The process identifies computing device groupings that are available for a task or have been instructed to perform the task (step 1200). In step 1200, these computing device groupings perform processing for the same task or are being considered for use in performing the same task.

The process determines a synergy between the available computing device groupings based on whether the computing device groupings will process the same data for the task and context (step 1202). The process selects computing device groupings from the available computing device groupings based on the synergy levels (step 1204). The process instructs the computing device groupings to collaborate in processing data for the task (step 1206).

The process determines if the computing device groupings are in communication with each other (step 1208). If the computing device groupings are not in communication with each other, the process deploys a set of relay devices to facilitate communications (step 1206). The process terminates thereafter. With reference again to step 1208, if the computing device groupings are in communication with each other, the process also terminates.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

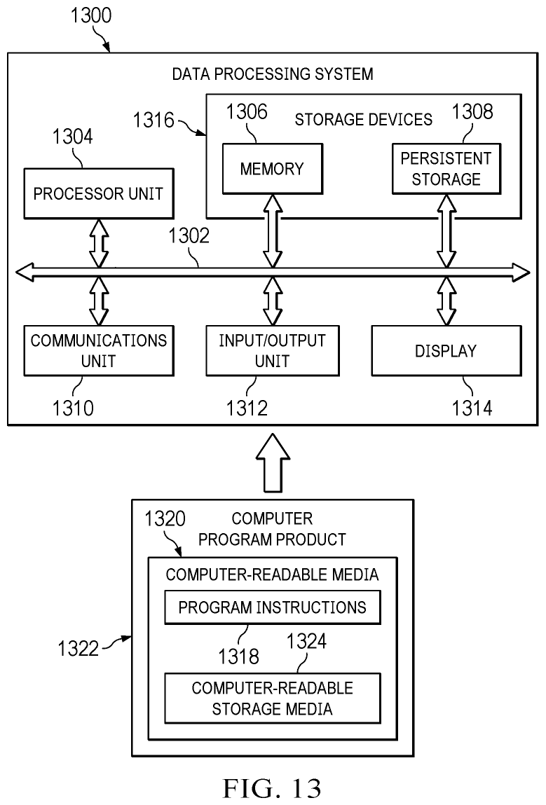

Turning now to FIG. 13, a block diagram of a data processing system is depicted in accordance with an illustrative embodiment. Data processing system 1300 can be used to implement computers and computing devices in computing environment 100 in FIG. 1. Data processing system 1300 can also be used to implement computer system 212 in FIG. 2. In this illustrative example, data processing system 1300 includes communications framework 1302, which provides communications between processor unit 1304, memory 1306, persistent storage 1308, communications unit 1310, input/output (I/O) unit 1312, and display 1314. In this example, communications framework 1302 takes the form of a bus system.

Processor unit 1304 serves to execute instructions for software that can be loaded into memory 1306. Processor unit 1304 includes one or more processors. For example, processor unit 1304 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1304 can be implemented using one or more heterogeneous processor systems in which a main processor is present with secondary processors on a single chip. As another illustrative example, processor unit 1304 can be a symmetric multi-processor system containing multiple processors of the same type on a single chip.

Memory 1306 and persistent storage 1308 are examples of storage devices 1316. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1316 may also be referred to as computer readable storage devices in these illustrative examples. Memory 1306, in these examples, can be, for example, a random-access memory or any other suitable volatile or non-volatile storage device. Persistent storage 1308 may take various forms, depending on the particular implementation.

For example, persistent storage 1308 may contain one or more components or devices. For example, persistent storage 1308 can be a hard drive, a solid-state drive (SSD), a flash memory, a rewritable optical disk, a rewritable magnetic tape, or some combination of the above. The media used by persistent storage 1308 also can be removable. For example, a removable hard drive can be used for persistent storage 1308.

Communications unit 1310, in these illustrative examples, provides for communications with other data processing systems or devices. In these illustrative examples, communications unit 1310 is a network interface card.

Input/output unit 1312 allows for input and output of data with other devices that can be connected to data processing system 1300. For example, input/output unit 1312 may provide a connection for user input through at least one of a keyboard, a mouse, or some other suitable input device. Further, input/output unit 1312 may send output to a printer. Display 1314 provides a mechanism to display information to a user.

Instructions for at least one of the operating system, applications, or programs can be located in storage devices 1316, which are in communication with processor unit 1304 through communications framework 1302. The processes of the different embodiments can be performed by processor unit 1304 using computer-implemented instructions, which may be located in a memory, such as memory 1306.

These instructions are referred to as program instructions, computer usable program instructions, or computer readable program instructions that can be read and executed by a processor in processor unit 1304. The program instructions in the different embodiments can be embodied on different physical or computer readable storage media, such as memory 1306 or persistent storage 1308.

Program instructions 1318 are located in a functional form on computer readable media 1320 that is selectively removable and can be loaded onto or transferred to data processing system 1300 for execution by processor unit 1304. Program instructions 1318 and computer readable media 1320 form computer program product 1322 in these illustrative examples. In the illustrative example, computer readable media 1320 is computer readable storage media 1324.

Computer readable storage media 1324 is a physical or tangible storage device used to store program instructions 1318 rather than a medium that propagates or transmits program instructions 1318. Computer readable storage media 1324, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1318 can be transferred to data processing system 1300 using a computer readable signal media. The computer readable signal media are signals and can be, for example, a propagated data signal containing program instructions 1318. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1320” can be singular or plural. For example, program instructions 1318 can be located in computer readable media 1320 in the form of a single storage device or system. In another example, program instructions 1318 can be located in computer readable media 1320 that is distributed in multiple data processing systems. In other words, some instructions in program instructions 1318 can be located in one data processing system while other instructions in program instructions 1318 can be located in one data processing system. For example, a portion of program instructions 1318 can be located in computer readable media 1320 in a server computer while another portion of program instructions 1318 can be located in computer readable media 1320 located in a set of client computers.

The different components illustrated for data processing system 1300 are not meant to provide architectural limitations to the manner in which different embodiments can be implemented. In some illustrative examples, one or more of the components may be incorporated in or otherwise form a portion of, another component. For example, memory 1306, or portions thereof, may be incorporated in processor unit 1304 in some illustrative examples. The different illustrative embodiments can be implemented in a data processing system including components in addition to or in place of those illustrated for data processing system 1300. Other components shown in FIG. 13 can be varied from the illustrative examples shown. The different embodiments can be implemented using any hardware device or system capable of running program instructions 1318.

Thus, illustrative embodiments provide a computer implemented method, computer system, and computer program product for computing device collaboration. In one example, a computer implemented method provides computing device collaboration in at least one of collecting and processing data. A number of processor units identify computing device groupings for collaboration in processing data based on synergy levels between the computing device groupings, wherein the computing device groupings process a set of common data types. The number of processor units instruct the computing device groupings to share the data for the set of common data types. The number of processor units deploy a number of relay devices to facilitate communications between the computing device groupings in response to the computing device groupings not being in communication with each other.

Thus, an illustrative example provides a desired level of collaboration though providing processing resources for performing different tasks. One illustrative example identifies computing device groupings that have synergy in processing data for a task. In this illustrative example, communications can be established for computing device groupings that are unable to communicate with each other using one or more relay devices. These relay devices establish communication paths that enable communications between the computing device groupings that have been selected to collaborate and process data.

As a result, one or more solutions enable identifying groups processing devices that can be used to collaborate with each other to scale or increase processing resources for performing a task. This ability to scale or increase processing resources can reduce latency, reduce bandwidth use, and increase processing performance.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for computing device collaboration, the computer implemented method comprising:
identifying, by a number of processor units, computing device groupings for collaboration in processing data based on synergy levels between the computing device groupings, wherein the computing device groupings process a set of common data types;
instructing, by the number of processor units, the computing device groupings to share the data for the set of common data types; and
deploying, by the number of processor units, a number of relay devices to facilitate communications between the computing device groupings in response to the computing device groupings not being in communication with each other.

2. The computer implemented method of claim 1, wherein identifying, by the number of processor units, the computing device groupings comprises:
identifying, by the number of processor units, multiple computing device groupings available for collaboration in processing the data for a task;
determining, by the number of processor units, synergy levels between the multiple computing device groupings for the task using a context for the multiple computing device groups; and
identifying, by the number of processor units, the computing device groupings for collaboration in processing data for the task from the multiple computing device groupings using the synergy levels.

3. The computer implemented method of claim 2, wherein identifying, by the number of processor units, the computing device groupings further comprises:
receiving, by the number of processor units, device information from computing devices in the multiple computing device groupings; and
determining, by the number of processor units, the context for the multiple computing device groupings from the device information received from the computing devices in the multiple computing device groupings.

4. The computer implemented method of claim 2, determining, by the number of processor units, synergy levels comprises:
determining, by the number of processor units, the synergy levels between the multiple computing device groupings using the context and a contextual need for the task.

5. The computer implemented method of claim 1, wherein deploying, by the number of processor units, the set of relay devices comprises:
determining, by the number of processor units, a set of optimal deployment locations to use a minimum number of relay devices for the set of relay devices in response to the computing device groupings not being in communication with each other; and
deploying the minimum number of relay devices at the set of optimal deployment locations.

6. The computer implemented method of claim 1, wherein determining, by the number of processor units, the set of optimal deployment locations comprises:
determining, by the number of processor units, the set of optimal deployment locations to use a minimum number of relay devices for the set of relay devices using a distance between the computing device groupings.

7. The computer implemented method of claim 6, wherein determining, by the number of processor units, the set of optimal deployment locations comprises:
determining, by the number of processor units, the set of optimal deployment locations to use a minimum number of relay devices for the set of relay devices using the distance and movement of computing devices in the computing device groupings.

8. The computer implemented method of claim 1, wherein deploying, by the number of processor units, the set of relay devices further comprises:
dynamically repositioning, by the number of processor units, the set of relay devices in response to an undesired level of communications occurring between the computing device groupings.

9. A computer system comprising:
a number of processor units, wherein the number of processor units execute program instructions to:
identify computing device groupings for collaboration in processing data based on synergy levels between the computing device groupings, wherein the computing device groupings process a set of common data types;
instruct the computing device groupings to share the data for the set of common data types; and
deploy a number of relay devices to facilitate communications between the computing device groupings in response to the computing device groupings not being in communication with each other.

10. The computer system of claim 9, wherein as part of identifying the computing device groupings, the number of processor units further execute the program instructions to:
identify multiple computing device groupings available for collaboration in processing the data for a task;
determine synergy levels between the multiple computing device groupings for the task using a context for the multiple computing device groups; and
identify the computing device groupings for collaboration in processing data for the task from the multiple computing device groupings using the synergy levels.

11. The computer system of claim 10, wherein as part of identifying the computing device groupings, the number of processor units further execute the program instructions to:
receive device information from computing devices in the multiple computing device groupings; and
determine the context for the multiple computing device groupings from the device information received from the computing devices in the multiple computing device groupings.

12. The computer system of claim 10, as part of determining synergy levels, the number of processor units further execute the program instructions to:
determine the synergy levels between the multiple computing device groupings using the context and a contextual need for the task.

13. The computer system of claim 9, as part of deploying the set of relay devices, the number of processor units further execute the program instructions to:
determine a set of optimal deployment locations to use a minimum number of relay devices for the set of relay devices in response to the computing device groupings not being in communication with each other; and
deploy the minimum number of relay devices at the set of optimal deployment locations.

14. The computer system of claim 9, as part of determining the set of optimal deployment locations, the number of processor units further execute the program instructions to:
determine the set of optimal deployment locations to use a minimum number of relay devices for the set of relay devices using a distance between the computing device groupings.

15. The computer system of claim 14, wherein as part of determining the set of optimal deployment locations, the number of processor units further execute the program instructions to:
determine the set of optimal deployment locations to use a minimum number of relay devices for the set of relay devices using the distance and movement of computing devices in the computing device groupings.

16. The computer system of claim 9 wherein as part of deploying the set of relay devices, the number of processor units further execute the program instructions to:
dynamically reposition the set of relay devices in response to an undesired level of communications occurring between the computing device groupings.

17. A computer program product for computing device collaboration, the computer program product comprising a computer readable storage medium having program instructions embodied therewith, the program instructions executable by a computer system to cause the computer system to:
identify computing device groupings for collaboration in processing data based on synergy levels between the computing device groupings, wherein the computing device groupings process a set of common data types;
instruct the computing device groupings to share the data for the set of common data types; and
deploy a number of relay devices to facilitate communications between the computing device groupings in response to the computing device groupings not being in communication with each other.

18. The computer program product of claim 17, wherein as part of identifying the computing device groupings, the program instructions are executable by the computer system to further cause the computer system to:
identify multiple computing device groupings available for collaboration in processing the data for a task;
determine synergy levels between the multiple computing device groupings for the task using a context for the multiple computing device groups; and
identify the computing device groupings for collaboration in processing data for the task from the multiple computing device groupings using the synergy levels.

19. The computer program product of claim 18, wherein as part of identifying the computing device groupings, the program instructions are executable by the computer system to further cause the computer system to:
receive device information from computing devices in the multiple computing device groupings; and
determine the context for the multiple computing device groupings from the device information received from the computing devices in the multiple computing device groupings.

20. The computer program product of claim 18, as part of determining synergy levels, the program instructions are executable by the computer system to further cause the computer system to:
determine the synergy levels between the multiple computing device groupings using the context and a contextual need for the task.
